(19) United States
(12) Patent Application Publication
(10) Pub. No.: US 2008/0055686 A1
(43) Pub. Date: Mar. 6, 2008

(54) Holographic data recording method and system

(76) Inventors: Christoph Georg Erben, Clifton Park, NY (US); Xiaolei Shi, Niskayuna, NY (US)

Correspondence Address: GENERAL ELECTRIC COMPANY (PCPI);C/O FLETCHER YODER, P. O. BOX 692289, HOUSTON, TX, 77269-2289, US

(21) Appl. No.: 11/515,605

(22) Filed: Sep. 5, 2006

(51) Int. Cl. G03H 1/02

(52) U.S. Cl. 359/4; 359/3

(57) ABSTRACT

Methods for holographic data storage are disclosed. The method includes providing an optically transparent substrate comprising a photochemically active dye and irradiating the optically transparent substrate with a holographic interference pattern and a photochromic conversion control illumination. The pattern has a first wavelength and an intensity both sufficient to convert, in the presence of the photochromic conversion control beam, within a volume element of the substrate, at least some of the photochemically active dye into a photo-product, and producing within the irradiated volume element concentration variations of the photo-product corresponding to the holographic interference pattern thereby producing an optically readable datum corresponding to the volume element. The photochromic conversion control illumination has a second wavelength and an intensity to control the photochromic conversion amplitude in the volume element.

### BACKGROUND

The invention relates generally to optical data storage techniques and more particularly to holographic data storage techniques.

Holographic storage is the storage of data in the form of holograms, which are images of three dimensional interference patterns created by the intersection of two beams of light, in a photosensitive storage medium. Both page-based holographic techniques and bit-wise holographic techniques have been pursued. In page-based holographic data storage, a signal beam which contains digitally encoded data, typically a plurality of bits, is superposed on a reference beam within the volume of the storage medium resulting in a chemical reaction which, for example, changes or modulates the refractive index of the medium within the volume. This modulation serves to record both the intensity and phase information from the signal. Each bit is therefore generally stored as a part of the interference pattern. The hologram can later be retrieved by exposing the storage medium to the reference beam alone, which interacts with the stored holographic data to generate a reconstructed signal beam proportional to the initial signal beam used to store the holographic image. In bit-wise holography or microholographic data storage, every bit is written as a microhologram or reflection grating typically generated by two counter propagating focused recording beams. The data is then retrieved by using a read beam to diffract off the microhologram to reconstruct the recording beam.

Early holographic storage media employed inorganic photo-refractive crystals, such as doped or un-doped lithium niobate (LiNbO₃), in which incident light creates refractive index changes. These refractive index changes are due to the photo-induced creation and subsequent trapping of electrons leading to an induced internal electric field that ultimately modifies the refractive index through a linear electro-optic effect. However, LiNbO₃ is expensive, exhibits relatively poor efficiency, fades over time, and requires thick crystals to observe any significant index changes.

Photopolymers that can sustain larger refractive index changes due to optically induced polymerization processes, have also been proposed for holographic storage medium. Because the medium may have a gel-like consistency it necessitates an ultraviolet (UV) curing step to provide form and stability. Unfortunately, the UV curing step may consume a large portion of the photo-active monomer or oligomer, leaving significantly less photo-active monomer or oligomer available for data storage. Furthermore, even under highly controlled curing conditions, the UV curing step may often result in variable degrees of polymerization and, consequently, poor uniformity among media samples.

More recently, dye-doped data storage materials based on polymeric materials have been developed. The dyes have a narrow absorption band at visible light wavelengths. Upon light absorption, they undergo a photochromic conversion, which produces a change of refractive index of the material, according to the Kramers-Kronig relation. Due to the resonant absorption of the dyes, the refractive index change could be high (˜0.01). This provides a beneficial potential for obtaining a high data capacity. In addition, the thermoplastic material has a much smaller shrinkage compared with photopolymer material and has very good optical quality, and is comparatively economical. These features make the dye-doped thermoplastics a very attractive candidate for holographic storage.

However, the dye photochromic conversion process is a linear process, i.e., there is no threshold functionality in it. In a page-based system, this may produce a problem of data erasure during readout, which may be fixed if a fixing process could be developed into the material. For a single-bit system, however, lack of threshold functionality may result in a loss of the material's dynamic range due to photochromic conversion of the dyes by background illumination. This produces a significant loss of the material's dynamic range (˜data capacity). For example, in a 40 layer single-bit system, ˜95% of the total dynamic range could be lost as a result of such background illumination. The problem is compounded when the layer number increases.

### BRIEF DESCRIPTION

Briefly, in accordance with aspects of the present technique, a method for holographic data recording is presented. The method includes providing an optically transparent substrate comprising a photochemically active dye and irradiating the optically transparent substrate with a holographic interference pattern and a photochromic conversion control illumination. The pattern has a first wavelength λ₁ and an intensity I₁ both sufficient to convert in the presence of the photochromic conversion control beam, within a volume element of the substrate, at least some of the photochemically active dye into a photo-product, and producing within the irradiated volume element concentration variations of the photo-product corresponding to the holographic interference pattern thereby producing an optically readable datum corresponding to the volume element. The photochromic conversion control illumination having a second wavelength λ₂ not equal to λ₁ and an intensity I₂ is used to control the photochromic conversion amplitude in the volume element.

In accordance with further aspects of the present technique, a prerecorded holographic data storage medium is presented. A pre-recorded holographic data storage medium prepared by method including providing an optically transparent substrate comprising a photochemically active dye and irradiating the optically transparent substrate with a holographic interference pattern and a photochromic conversion control illumination. The pattern has a first wavelength λ₁ and an intensity I₁ both sufficient to convert in the presence of the photochromic conversion control beam, within a volume element of the substrate, at least some of the photochemically active dye into a photo-product, and producing within the irradiated volume element concentration variations of the photo-product corresponding to the holographic interference pattern thereby producing an optically readable datum corresponding to the volume element. The photochromic conversion control illumination having a second wavelength λ₂ not equal to λ₁ and an intensity I₂ is used to control the photochromic conversion amplitude in the volume element. The data storage medium includes greater than 4 recorded layers in the thickness of the holographic data storage medium.

According to further aspects of the present technique, a system for holographic data recording is presented. The system includes a holographic interference pattern generating source, wherein the holographic interference pattern having an Intensity I_{1,0} and photochromic conversion fluence F₁ within a recording volume element. The system further includes a photochromic conversion control illumination generating source, wherein the photochromic conversion control illumination has an intensity I₂ and photochromic conversion fluence F₂ within the recording volume element, wherein α=(F₁/F₂)(I₂/I_{1,0}) is in a range from about 0.1 to 10.

### DRAWINGS

These and other features, aspects, and advantages of the present invention will become better understood when the following detailed description is read with reference to the accompanying drawings in which like characters represent like parts throughout the drawings, wherein:

FIG. 1 is a schematic representation of a single wavelength bit-wise holographic recording system, according to aspects of the present technique;

FIG. 2 is a graph illustrating the absorption changes during the reversible photochromic conversion in dependence of the illumination wavelength which is used for a dual wavelength photochromic conversion process according to aspects of the present technique;

FIG. 3 is a flow chart illustrating an exemplary process of dual wavelength holographic data recording according to aspects of the present technique;

FIG. 4 is a schematic representation of a dual wavelength bit-wise holographic recording system, according to aspects of the present technique;

FIG. 5 is a schematic representation of a dual wavelength photochromic conversion system, according to aspects of the present technique;

FIG. 6 is a graph illustrating transmission intensity versus single wavelength photochromic conversion duration according to aspects of the present technique; and

FIG. 7 is a graph illustrating variation in photochromic conversion fluence and normalized photochromic conversion amplitude with intensity ratio according to aspects of the present technique.

### DETAILED DESCRIPTION

Some aspects of the present invention and general scientific principles used herein can be more clearly understood by referring to U.S. Patent Application 2005/0136333 (Ser. No. 10/742,461), which was published on Jun. 23, 2005; co-pending application having Ser. No. 10/954,779, filed on Sep. 30, 2004; and co-pending application having Ser. No. 11/260,806, filed on Oct. 27, 2005; all of which are incorporated herein by reference in their entirety. It should be noted that with respect to the interpretation and meaning of terms in the present application, in the event of a conflict between this application and any document incorporated herein by reference, the conflict is to be resolved in favor of the definition or interpretation provided by the present application.

As used herein, the term “aromatic radical” refers to an array of atoms having a valence of at least one comprising at least one aromatic group. The array of atoms having a valence of at least one comprising at least one aromatic group may include heteroatoms such as nitrogen, sulfur, selenium, silicon and oxygen, or may be composed exclusively of carbon and hydrogen. As used herein, the term “aromatic radical” includes but is not limited to phenyl, pyridyl, furanyl, thienyl, naphthyl, phenylene, and biphenyl radicals. As noted, the aromatic radical contains at least one aromatic group. The aromatic group is invariably a cyclic structure having 4n+2 “delocalized” electrons where “n” is an integer equal to 1 or greater, as illustrated by phenyl groups (n=1), thienyl groups (n=1), furanyl groups (n=1), naphthyl groups (n=2), azulenyl groups (n=2), anthraceneyl groups (n=3) and the like. The aromatic radical may also include nonaromatic components. For example, a benzyl group is an aromatic radical which comprises a phenyl ring (the aromatic group) and a methylene group (the nonaromatic component). Similarly a tetrahydronaphthyl radical is an aromatic radical comprising an aromatic group (C₆H₃) fused to a nonaromatic component —(CH₂)₄—. For convenience, the term “aromatic radical” is defined herein to encompass a wide range of functional groups such as alkyl groups, alkenyl groups, alkynyl groups, haloalkyl groups, haloaromatic groups, conjugated dienyl groups, alcohol groups, ether groups, aldehyde groups, ketone groups, carboxylic acid groups, acyl groups (for example carboxylic acid derivatives such as esters and amides), amine groups, nitro groups, and the like. For example, the 4-methylphenyl radical is a C₇ aromatic radical comprising a methyl group, the methyl group being a functional group which is an alkyl group. Similarly, the 2-nitrophenyl group is a C₆ aromatic radical comprising a nitro group, the nitro group being a functional group. Aromatic radicals include halogenated aromatic radicals such as 4-trifluoromethylphenyl, hexafluoroisopropylidenebis(4-phen-1-yloxy) (i. e., —OPhC(CF₃)₂PhO—), 4-chloromethylphen-1-yl, 3-trifluorovinyl-2-thienyl, 3-trichloromethylphen-1-yl (i.e., 3-CCl₃Ph-), 4-(3-bromoprop-1-yl)phen-1-yl (i.e., 4-BrCH₂CH₂CH₂Ph-), and the like. Further examples of aromatic radicals include 4-allyloxyphen-1-oxy, 4-aminophen-1-yl (i.e., 4-H₂NPh-), 3-aminocarbonylphen-1-yl (i.e., NH₂COPh-), 4-benzoylphen-1-yl, dicyanomethylidenebis(4-phen-1-yloxy) (i.e., —OPhC(CN)₂PhO—), 3-methylphen-1-yl, methylenebis(4-phen-1-yloxy) (i.e., —OPhCH₂PhO—), 2-ethylphen-1-yl, phenylethenyl, 3-formyl-2-thienyl, 2-hexyl-5-furanyl, hexamethylene-1,6-bis(4-phen-1-yloxy) (i.e., —OPh(CH₂)₆PhO—), 4-hydroxymethylphen-1-yl (i.e., 4-HOCH₂Ph-), 4-mercaptomethylphen-1-yl (i.e., 4-HSCH₂Ph-), 4-methylthiophen-1-yl (i.e., 4-CH₃ SPh-), 3-methoxyphen-1-yl, 2-methoxycarbonylphen-1-yloxy (e.g., methyl salicyl), 2-nitromethylphen-1-yl (i.e., 2-NO₂CH₂Ph), 3-trimethylsilylphen-1-yl, 4-t-butyldimethylsilylphenl-1-yl, 4-vinylphen-1-yl, vinylidenebis(phenyl), and the like. The term “a C₃-C₁₀ aromatic radical” includes aromatic radicals containing at least three but no more than 10 carbon atoms. The aromatic radical 1-imidazolyl (C₃H₂N₂—) represents a C₃ aromatic radical. The benzyl radical (C₇H₇—) represents a C₇ aromatic radical.

As used herein the term “cycloaliphatic radical” refers to a radical having a valence of at least one, and comprising an array of atoms which is cyclic but which is not aromatic. As defined herein a “cycloaliphatic radical” does not contain an aromatic group. A “cycloaliphatic radical” may comprise one or more noncyclic components. For example, a cyclohexylmethyl group (C₆H₁₁CH₂—) is a cycloaliphatic radical which comprises a cyclohexyl ring (the array of atoms which is cyclic but which is not aromatic) and a methylene group (the noncyclic component). The cycloaliphatic radical may include heteroatoms such as nitrogen, sulfur, selenium, silicon and oxygen, or may be composed exclusively of carbon and hydrogen. For convenience, the term “cycloaliphatic radical” is defined herein to encompass a wide range of functional groups such as alkyl groups, alkenyl groups, alkynyl groups, haloalkyl groups, conjugated dienyl groups, alcohol groups, ether groups, aldehyde groups, ketone groups, carboxylic acid groups, acyl groups (for example carboxylic acid derivatives such as esters and amides), amine groups, nitro groups, and the like. For example, the 4-methylcyclopent-1-yl radical is a C₆ cycloaliphatic radical comprising a methyl group, the methyl group being a functional group which is an alkyl group. Similarly, the 2-nitrocyclobut-1-yl radical is a C₄ cycloaliphatic radical comprising a nitro group, the nitro group being a functional group. A cycloaliphatic radical may comprise one or more halogen atoms which may be the same or different. Halogen atoms include, for example; fluorine, chlorine, bromine, and iodine. Cycloaliphatic radicals comprising one or more halogen atoms include 2-trifluoromethylcyclohex-1-yl, 4-bromodifluoromethylcyclooct-1-yl, 2-chlorodifluoromethylcyclohex-1-yl, hexafluoroisopropylidene-2,2-bis (cyclohex-4-yl) (i.e., —C₆H₁₀C(CF₃)₂C₆H₁₀—), 2-chloromethylcyclohex-1-yl, 3-difluoromethylenecyclohex-1-yl, 4-trichloromethylcyclohex-1-yloxy, 4-bromodichloromethylcyclohex-1-ylthio, 2-bromoethylcyclopent-1-yl, 2-bromopropylcyclohex-1-yloxy (e.g., CH₃CHBrCH₂C₆H₁₀O—), and the like. Further examples of cycloaliphatic radicals include 4-allyloxycyclohex-1-yl, 4-aminocyclohex-1-yl (i.e., H₂NC₆H₁₀—), 4-aminocarbonylcyclopent-1-yl (i.e., NH₂COC₅H₈—), 4-acetyloxycyclohex-1-yl, 2,2-dicyanoisopropylidenebis(cyclohex-4-yloxy) (i.e., —OC₆H₁₀C(CN)₂C₆H₁₀O—), 3-methylcyclohex-1-yl, methylenebis(cyclohex-4-yloxy) (i.e., —OC₆H₁₀CH₂C₆H₁₀O—), 1-ethylcyclobut-1-yl, cyclopropylethenyl, 3-formyl-2-terahydrofuranyl, 2-hexyl-5-tetrahydrofuranyl, hexamethylene-1,6-bis(cyclohex-4-yloxy) (i.e., —OC₆H₁₀(CH₂)₆C₆H₁₀O—), 4-hydroxymethylcyclohex-1-yl (i.e., 4-HOCH₂C₆H₁₀—), 4-mercaptomethylcyclohex-1-yl (i.e., 4-HSCH₂C₆H₁₀—), 4-methylthiocyclohex-1-yl (i.e., 4-CH₃SC₆H₁₀—), 4-methoxycyclohex-1-yl, 2-methoxycarbonylcyclohex-1-yloxy (2-CH₃OCOC₆H₁₀O—), 4-nitromethylcyclohex-1-yl (i.e., NO₂CH₂C₆H₁₀—), 3-trimethylsilylcyclohex-1-yl, 2-t-butyldimethylsilylcyclopent-1-yl, 4-trimethoxysilylethylcyclohex-1-yl (e.g., (CH₃O)₃SiCH₂CH₂C₆H₁₀—), 4-vinylcyclohexen-1-yl, vinylidenebis(cyclohexyl), and the like. The term “a C₃-C₁₀ cycloaliphatic radical” includes cycloaliphatic radicals containing at least three but no more than 10 carbon atoms. The cycloaliphatic radical 2-tetrahydrofuranyl (C₄H₇O—) represents a C₄ cycloaliphatic radical. The cyclohexylmethyl radical (C₆H₁₁CH₂—) represents a C₇ cycloaliphatic radical.

As used herein the term “aliphatic radical” refers to an organic radical having a valence of at least one consisting of a linear or branched array of atoms which is not cyclic. Aliphatic radicals are defined to comprise at least one carbon atom. The array of atoms comprising the aliphatic radical may include heteroatoms such as nitrogen, sulfur, silicon, selenium and oxygen or may be composed exclusively of carbon and hydrogen. For convenience, the term “aliphatic radical” is defined herein to encompass, as part of the “linear or branched array of atoms which is not cyclic” a wide range of functional groups such as alkyl groups, alkenyl groups, alkynyl groups, haloalkyl groups, conjugated dienyl groups, alcohol groups, ether groups, aldehyde groups, ketone groups, carboxylic acid groups, acyl groups (for example carboxylic acid derivatives such as esters and amides), amine groups, nitro groups, and the like. For example, the 4-methylpent-1-yl radical is a C₆ aliphatic radical comprising a methyl group, the methyl group being a functional group which is an alkyl group. Similarly, the 4-nitrobut-1-yl group is a C₄ aliphatic radical comprising a nitro group, the nitro group being a functional group. An aliphatic radical may be a haloalkyl group which comprises one or more halogen atoms which may be the same or different. Halogen atoms include, for example; fluorine, chlorine, bromine, and iodine. Aliphatic radicals comprising one or more halogen atoms include the alkyl halides trifluoromethyl, bromodifluoromethyl, chlorodifluoromethyl, hexafluoroisopropylidene, chloromethyl, difluorovinylidene, trichloromethyl, bromodichloromethyl, bromoethyl, 2-bromotrimethylene (e.g., —CH₂CHBrCH₂—), and the like. Further examples of aliphatic radicals include allyl, aminocarbonyl (i.e., —CONH₂), carbonyl, 2,2-dicyanoisopropylidene (i.e., —CH₂C(CN)₂CH₂—), methyl (i.e., —CH₃), methylene (i.e., —CH₂—), ethyl, ethylene, formyl (i.e., —CHO), hexyl, hexamethylene, hydroxymethyl (i.e., —CH₂OH), mercaptomethyl (i.e., —CH₂SH), methylthio (i.e., —SCH₃), methylthiomethyl (i.e., —CH₂SCH₃), methoxy, methoxycarbonyl (i.e., CH₃OCO—), nitromethyl (i.e., —CH₂NO₂), thiocarbonyl, trimethylsilyl ( i.e., (CH₃)₃Si—), t-butyldimethylsilyl, 3-trimethyoxysilypropyl (i.e., (CH₃O)₃SiCH₂CH₂CH₂—), vinyl, vinylidene, and the like. By way of further example, a C₁-C₁₀ aliphatic radical contains at least one but no more than 10 carbon atoms. A methyl group (i.e., CH₃—) is an example of a C₁ aliphatic radical. A decyl group (i.e., CH₃(CH₂)₉—) is an example of a C₁₀ aliphatic radical.

As defined herein, the term “optically transparent” as applied to an optically transparent substrate or an optically transparent plastic material means that the substrate or plastic material has an absorbance of less than 1. That is, at least 10 percent of incident light is transmitted through the material at at least one wavelength in a range between about 300 and about 800 nanometers. For example, when configured as a film having a thickness suitable for use in holographic data storage said film exhibits an absorbance of less than 1 at at least one wavelength in a range between about 300 and about 800 nanometers.

As defined herein, the term “volume element” means a three dimensional portion of a total volume.

As defined herein, the term “optically readable datum” can be understood as a datum that is stored as a hologram patterned within one or more volume elements of an optically transparent substrate.

As defined herein, the term “photochromic conversion” refers to the property of a molecule that it can be converted from a stable state A to a stable state B by a wavelength λ_{A}. This conversion is accompanied by a change in the visible absorption spectrum and the refractive index of the material.

As defined herein, the term “reversible photochromic conversion” refers to the property of a molecule that it can be converted from a stable state A to a stable state B by a wavelength λ_{A} and subsequently from the stable state B to the stable state A by a wavelength λ_{B}.

As noted, holographic data storage relies upon the introduction of localized variations in the refractive index of the optically transparent substrate comprising the photochemically active dye as a means of storing holograms. The refractive index within an individual volume element of the optically transparent substrate may be constant throughout the volume element, as in the case of a volume element that has not been exposed to electromagnetic radiation, or in the case of a volume element in which the photochemically active dye has been reacted to the same degree throughout the volume element. It is believed that most volume elements that have been exposed to electromagnetic radiation during the holographic data writing process will contain a complex holographic pattern, and as such, the refractive index within the volume element will vary across the volume element. In instances in which the refractive index within the volume element varies across the volume element, it is convenient to regard the volume element as having an “average refractive index” which may be compared to the refractive index of the corresponding volume element prior to irradiation. Thus, in one embodiment an optically readable datum comprises at least one volume element having a refractive index that is different from a (the) corresponding volume element of the optically transparent substrate prior to irradiation. Data storage is achieved by locally changing the refractive index of the data storage medium in a graded fashion (for example, continuous sinusoidal variations), and then using the induced changes as diffractive optical elements.

As used herein, the term “dynamic range” is a measure of the data storage capacity of the holographic storage medium. It is related to the number of detectable holograms which can be recorded in the medium and can be equivalently considered as the total refractive index change of storage medium material.

The capacity to store data as holograms is also directly proportional to the ratio of the change in refractive index per unit dye density (Δn/N₀) at the wavelength used for reading the data to the absorption cross section (σ) at a given wavelength used for writing the data as a hologram. The refractive index change per unit dye density is given by the ratio of the difference in refractive index of the volume element before irradiation minus the refractive index of the same volume element after irradiation to the density of the dye molecules. The refractive index change per unit dye density has a unit of cm³. Thus in an embodiment, the optically readable datum comprises at least one volume element wherein the ratio of the change in the refractive index per unit dye density of the at least one volume element to an absorption cross section of the at least one photochemically active dye is at least about 10⁻⁵ expressed in units of centimeter.

Sensitivity (S) is a measure of the diffraction efficiency of a hologram recorded using a certain amount of light fluence (F). The light fluence (F) is given by the product of light intensity (I) and recording time (t). Mathematically, sensitivity is given by equation (3),

$$S = \frac{\sqrt{η}}{I \cdot t \cdot L} ( cm / J ) \qquad Equation ( 3 )$$

wherein I is the intensity of the recording beam, “t” is the recording time, L is the thickness of the recording (or data storage) medium (example, disc), and n is the diffraction efficiency. Diffraction efficiency is given by equation (4),

$$η = {sin}^{2} ( \frac{π \cdot Δ n \cdot L}{λ \cdot cos ( θ )} ) \qquad Equation ( 4 )$$

wherein λ is the wavelength of light in the recording medium, θ is the recording angle in the media, and Δn is the refractive index contrast of the grating, which is produced by the recording process, wherein the dye molecule undergoes a photochromic conversion.

The absorption cross section is a measurement of an atom or molecule's ability to absorb light at a specified wavelength, and is measured in square cm/molecule. It is generally denoted by σ(λ) and is governed by the Beer-Lambert Law for optically thin samples as shown in equation (5),

$$σ ( λ ) - ln ( 10 ) \cdot \frac{Absorbance ( λ )}{{N}_{o} \cdot L} ( {cm}^{2} ) \qquad Equation ( 5 )$$

wherein N₀ is the concentration in molecules per cubic centimeter, and L is the sample thickness in centimeters.

Quantum efficiency (QE) is a measure of the probability of a photochemical transition for each absorbed photon of a given wavelength. Thus, it gives a measure of the efficiency with which incident light is used to achieve a given photochromic conversion. QE is given by equation (6),

$$QE = \frac{hc / λ}{σ \cdot {F}_{0}} \qquad Equation ( 6 )$$

wherein “h” is the Planck's constant, “c” is the velocity of light, σ(λ) is the absorption cross section at the wavelength λ, and F₀ is the photochromic conversion fluence. The parameter F₀ is given by the product of light intensity (I) and a time constant (τ) that characterizes the photochromic conversion process.

Typically, the photochemically active dyes undergo a light induced chemical reaction when exposed to light with a wavelength within the absorption range to form at least one photo-product. This reaction can be a photo-decomposition reaction, such as oxidation, reduction, or bond breaking to form smaller constituents, or a molecular rearrangement, such as a sigmatropic rearrangement, or addition reactions including pericyclic cycloadditions. Thus in an embodiment, data storage in the form of holograms is achieved wherein the photo-product is patterned (for example, in a graded fashion) within the modified optically transparent substrate to provide the at least one optically readable datum.

Photochemically active dyes that are particularly suited for the current invention are dyes that can undergo a reversible photochromic conversion. Thus, in one embodiment, data storage in the form of holograms is achieved wherein the photo-product is patterned (for example, in a graded fashion) within the modified optically transparent substrate by irradiation with a wavelength λ₁ to provide the at least one optically readable datum, while irradiation with a wavelength λ₂ is provided to further control the photochromic conversion amplitude in the volume element. The irradiation with a wavelength λ₂ can either occur simultaneously or sequentially to the irradiation with the wavelength λ₁.

Typically, the reversible conversion does not have the same time constant in both directions. Furthermore, the quantum efficiencies for the two reaction pathways and the absorption cross sections of the reaction products are not necessarily the same. Examples of suitable reversible photochromic dyes comprise vicinal diarylethenes, fulgides and fulgimides, spiropyrans, spirooxazines, naphtopyrans and combinations thereof.

Examples of suitable diarylethenes that can be used as photochemically active dyes include but are not limited to diarylperfluorocyclopentenes, diarylmaleic anhydrides, diarylmaleimides, or a combination comprising at least one of the foregoing diarylethenes. The vicinal diarylethenes can be prepared using methods known in the art. The diarylethenes are present as open-ring or closed-ring isomers. In general, the open ring isomers of diarylethenes have absorption bands at shorter wavelengths. Upon irradiation with ultraviolet light, new absorption bands appear at longer wavelengths, which are ascribed to the closed-ring isomers. The absorption spectra of the open and closed-ring isomers may depend on the substituents of the thiophene rings, naphthalene rings or the phenyl rings. The absorption structures of the open and closed-ring isomers may depend upon the upper cycloalkene structures. For example, the open-ring isomers of maleic anhydride or maleimide derivatives show spectral shifts to longer wavelengths in comparison with the perfluorocyclopentene derivatives.

An exemplary class of vicinal diarylethene compounds can be represented by generic structure (I),

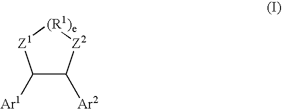

wherein “e” is 0 or 1; R¹ is a bond, an oxygen atom, a substituted nitrogen atom, a sulfur atom, a selenium atom, a divalent C₁-C₂₀ aliphatic radical, a halogenated divalent C₁-C₂₀ aliphatic radical, a divalent C₃-C₂₀ cycloaliphatic radical, a halogenated divalent C₁-C₂₀ cycloaliphatic radical, or a divalent C₂-C₃₀ aromatic radical; Ar¹ and Ar² are each independently a C₂-C₄₀ aromatic radical, or a C₂-C₄₀ heteroaromatic radical; and Z¹ and Z² are independently a bond, a hydrogen atom, a monovalent C₁-C₂₀ aliphatic radical, divalent C₁-C₂₀ aliphatic radical, a monovalent C₃-C₂₀ cycloaliphatic radical, a divalent C₃-C₂₀ cycloaliphatic radical, a monovalent C₂-C₃₀ aromatic radical, or a divalent C₂-C₃₀ aromatic radical. It should be noted that each of the aromatic radicals Ar¹ and Ar² are identical or different as are the groups Z¹ and Z². It will be understood by those skilled in the art that Ar¹ may differ in structure from Ar² and that Z¹ may differ in structure from Z², and that such species are encompassed within generic structure I and are included within the scope of the instant invention.

In another embodiment, e is 0, and Z¹ and Z² C₁-C₅ alkyl, C₁-C₅ perfluoroalkyl, or CN. In still another embodiment, e is 1, and Z¹ and Z² are independently CH₂, CF₂, or C═O. In yet another embodiment, Ar¹ and Ar² are each independently an aromatic radical selected from the group consisting of phenyl, anthracenyl, phenanthrenyl, pyridinyl, pyridazinyl, 1H-phenalenyl and naphthyl, optionally substituted by one or more substituents, wherein the substituents are each independently C₁-C₃ alkyl, C₁-C₃ perfluoroalkyl, C₁-C₃ alkoxy, or fluorine. In yet another embodiment at least one of Ar¹ and Ar² comprises one or more aromatic moieties selected from the group consisting of structures (II), (III), and (IV),

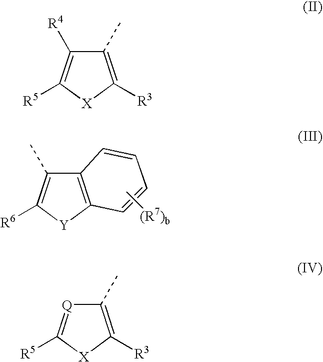

wherein R³, R⁴, R⁵, and R⁶ are hydrogen, a halogen atom, a nitro group, a cyano group, a C₁-C₁₀ aliphatic radical, a C₃-C₁₀ cycloaliphatic radical, or a C₂-C₁₀ aromatic radical; R⁷ is independently at each occurrence a halogen atom, a nitro group, a cyano group, a C₁-C₁₀ aliphatic radical, a C₃-C₁₀ cycloaliphatic radical, or a C₂-C₁₀ aromatic radical; “b” is an integer from and including 0 to and including 4; X and Y are selected from the group consisting of sulfur, selenium, oxygen, NH, and nitrogen substituted by a C₁-C₁₀ aliphatic radical, a C₃-C₁₀ cycloaliphatic radical, or a C₂-C₁₀ aromatic radical; and Q is CH or N. In one embodiment, at least one of R³, R⁴, R⁵, and R⁶ is selected from the group consisting of hydrogen, fluorine, chlorine, bromine, C₁-C₃ alkyl, C₁-C₃ perfluoroalkyl, cyano, phenyl, pyridyl, isoxazolyl, —CHC(CN)₂.

The vicinal diarylethenes can be reacted in the presence of actinic radiation (i.e. radiation that can produce a photochemical reaction), such as light. In one embodiment, an exemplary vicinal diarylethene can undergo a reversible cyclization reaction in the presence of light (hν) according to the following equation (V):

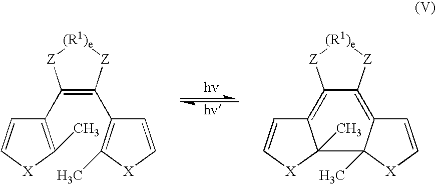

where X, Z R¹ and e have the meanings indicated above. The cyclization reactions can be used to produce holograms. The holograms can be produced by using radiation to effect the cyclization reaction or the reverse ring-opening reaction. The cyclization reaction is a photochromic reaction, whereby a form change results in change in refractive index. Typically, hν′ is lower in energy (longer wavelength) than hν. Typically, if the cyclization reaction is initiated at an ultra violet wavelength, then the reverse ring opening reaction typically occurs at a visible or infrared wavelength.

As described above, cyclization reactions can be used to produce holograms. The holograms can be produced by using radiation to effect the cyclization reaction or the reverse ring-opening reaction. Thus, in an embodiment, a photo-product derived from a vicinal diarylethene can be used as a photochemically active dye. Such photo-products derived from the vicinal diarylethene can be represented by a formula (VI),

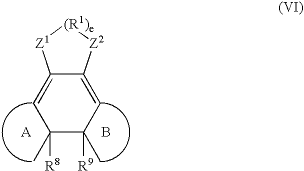

wherein “e”, R¹, Z¹, and Z² are as described for the vicinal diarylethene having formula (I), A and B are fused rings, and R⁸ and R⁹ are each independently a hydrogen atom, an aliphatic radical, a cycloaliphatic radical, or an aromatic radical. One or both fused rings A and B may comprise carbocyclic rings which do not have heteroatoms. In another embodiment, the fused rings A and B may comprise one or more heteroatoms selected from the group consisting of oxygen, nitrogen, and sulfur.

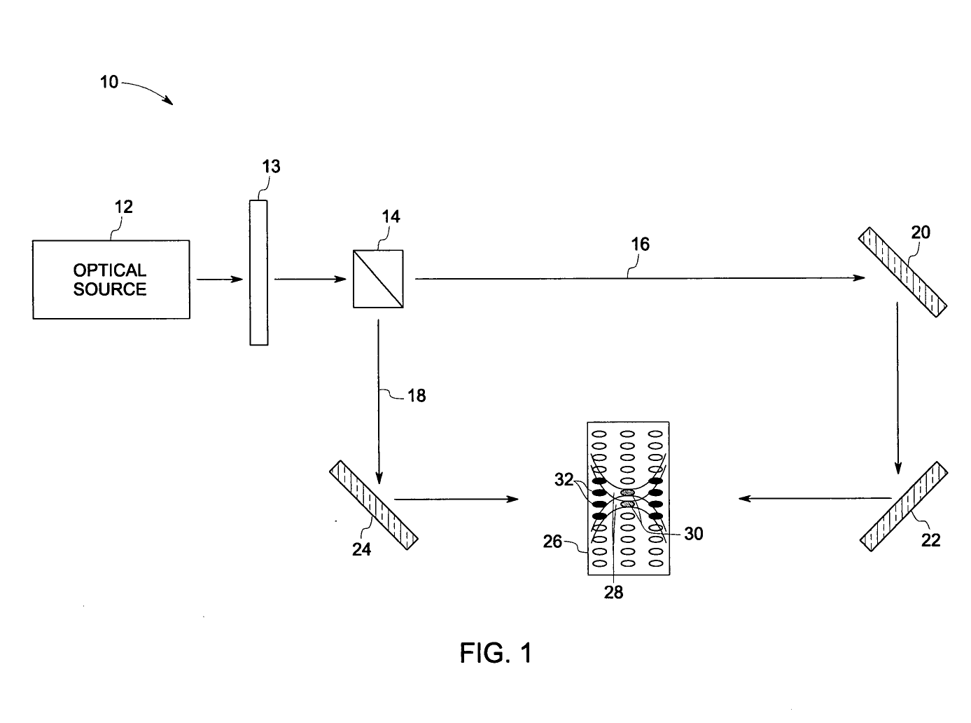

A single wavelength bit wise holographic recording system 10 is illustrated in FIG. 1. The system 10 includes an optical source 12, such as a laser, which emits coherent radiation in the blue-violet region, which is split into at least two beams 16, 18 by beam splitter 14. Beams 16 and 18 are steered towards a point in the volume of a holographic data storage medium 26 by a series of mirrors 20, 22, 24. Additional focusing optics may be used to focus the beams to a spot and at various depths within the volume of the holographic medium 26. The beams interfere within the volume of the medium 26 to record the data as holographic microgratings (microholograms) 30. In some systems, pulsed lasers are used. In other systems, the output of the optical source 12, such as a CW (continuous wave) laser, may be pulsed using controllable shutters 13, electro-optic modulators or acousto-optic modulators, for example.

As shown schematically in FIG. 1, while dyes in the waist 28 of the recording beams are bleached to form microholograms, the dyes 32 that are out of the beam waist 28 but within the beam illumination cone are bleached as well. This produces a significant loss of the material's dynamic range. For example, in a 40 layer single-bit system, ˜95% of the total dynamic range could be lost as a result of such background photochromic conversion. The problem is compounded as the number of recorded layers increases.

The photochromic conversion process of the dyes can be analyzed using a rate equation model. The total density of the dye molecules is N₀, the density of dyes in the ring-open form is N(t), and a beam, for example blue beam, has the intensity I_{b}, For a single wavelength photochromic conversion process the photochromic conversion dynamics of the dyes for a ring-open to ring close cyclization reaction, can be described using the following rate equation:

$$\frac{d N ( t )}{d t} = - N ( t ) \cdot \frac{{I}_{b}}{( \frac{hc}{{λ}_{b}} )} \cdot {σ}_{b} \cdot {η}_{b} \qquad Equation ( 7 )$$

where σ_{b} is absorption cross-section of the dyes at the blue wavelength when the dyes are in the ring-open form, η_{b} is quantum efficiency of the dye transition from the ring-open to the ring-close form when a photon at blue wavelength is absorbed, λ_{b} is the blue wavelength, h is the Planck constant, c is the speed of light.

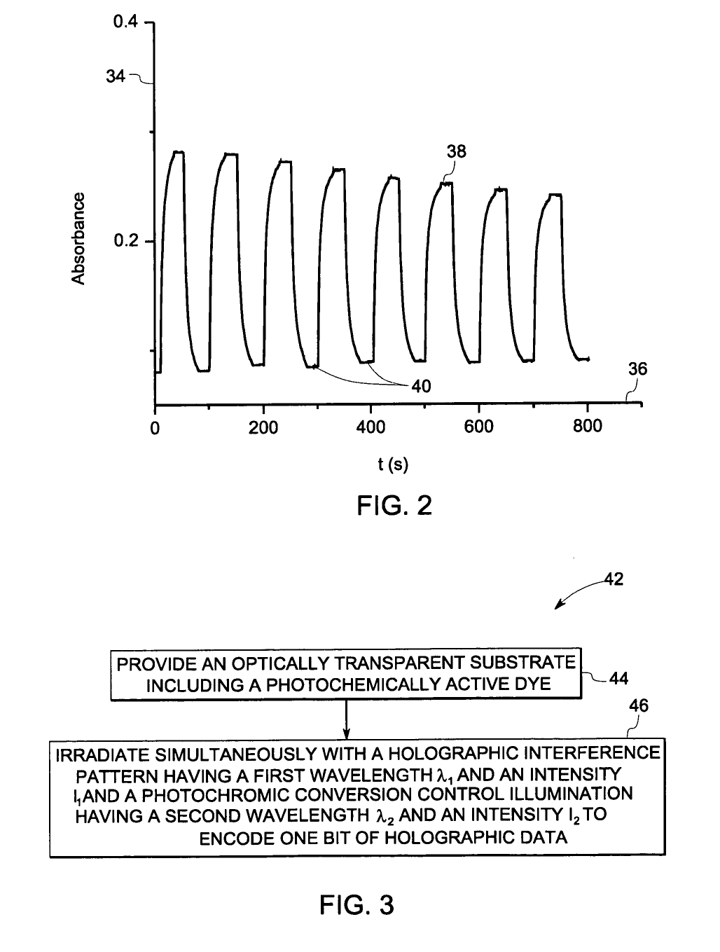

Reversible diarylethene dyes can be bleached in a reversible fashion as indicated above. This result is illustrated in FIG. 2. FIG. 2 illustrates experimentally observed variation in absorbance (Y-axis 34) at a wavelength of 550 nm versus photochromic conversion time (X-axis 36) for a diarylethene dye. The sample is prepared in form of an injection molded polycarbonate OQ disc with a 0.25 w % doping level of a diarylethene dye. The dye molecules in the polycarbonate substrate were subjected to alternative photochromic conversion by blue light (405 nm) and green light (532 nm) illumination. Under the blue light illumination, the dye molecules changed from a ring-open form to a ring-close form; under a green light illumination, the dye molecules change in an opposite direction, from the ring-close form to the ring-open form. The exposure time at each wavelength was about 60 seconds and, after a 10 seconds dark period, switched to exposure at the other wavelength. The absorbance profile showing alternate maxima 38 and minima 40, clearly indicating that the dye was being reversibly bleached on alternating forward and reverse photochromic conversion illumination.

For a dual wavelength photochromic conversion process where a blue beam effects the cyclization reaction and a green beam effects the reverse ring opening reaction, the rate equation is given by

$$\frac{d N ( t )}{d t} = - N ( t ) \cdot \frac{{I}_{b}}{( \frac{hc}{{λ}_{b}} )} \cdot {σ}_{b} \cdot {η}_{b} + ( {N}_{0} - N ( t ) ) \cdot \frac{{I}_{g}}{( \frac{hc}{{λ}_{g}} )} \cdot {σ}_{g} \cdot {η}_{g} \qquad Equation ( 8 )$$

where σ_{g} is absorption cross-section at the green wavelength when the dyes are in the ring-close form; I_{g}, the green beam intensity, λ_{g} the green wavelength, η_{g} is quantum efficiency for transition from the ring-close to the ring-open form when a photon at green wavelength is absorbed.

Solution to this rate equation is:

$$\frac{N ( t )}{{N}_{0}} = ( 1 - \frac{{N}_{t \to ∞}}{{N}_{0}} ) \cdot {e}^{- \frac{t}{τ}} + \frac{{N}_{t \to ∞}}{{N}_{0}} \\ \frac{{N}_{t \to ∞}}{{N}_{0}} = \frac{1 / {τ}_{g}}{1 / {τ}_{b} + 1 / {τ}_{g}} \\ 1 / τ = 1 / {τ}_{b} + 1 / {τ}_{g} \\ 1 / {τ}_{b} = \frac{{I}_{b} \cdot {σ}_{b} \cdot {η}_{b} \cdot {λ}_{b}}{hc} \\ 1 / {τ}_{g} = \frac{{I}_{g} \cdot {σ}_{g} \cdot {η}_{g} \cdot {λ}_{g}}{hc} \qquad Equation ( 9 )$$

where N_{t→∞} is density of the dyes in the ring-open at the steady state, τ is photochromic conversion time constant for the dye transition from the ring-open to the ring-close form for dual wavelength photochromic conversion with both blue and green illumination, τ_{b} is the photochromic conversion time constant for the dye transition from the ring-open to the ring-close form if there is only a blue beam illumination with intensity I_{b}, and τ_{g} is the photochromic conversion time constant for the dye transition from the ring-close to the ring-open form if there is only a green beam illumination with intensity I_{g}.

Photochromic conversion fluence F (mJ/cm²) and normalized photochromic conversion amplitude A are two parameters that can be used to describe a photochromic conversion process. The photochromic conversion fluence F is a product of the beam intensity I and time constant τ of the photochromic conversion process. Normalized photochromic conversion amplitude A is a ratio of a change of the transmitted power to the initial transmitted power at the beginning of the photochromic conversion. Both parameters are determined by the internal properties of the dyes (such as absorption cross-section, quantum efficiency) and light beam intensities, and are independent of dye concentrations and material uniformity. Both parameters can be measured experimentally.

The single wavelength photochromic conversion fluence for example, blue and green illumination, F_{b}, F_{g} respectively are given by

$${F}_{b} ≡ {I}_{b} \cdot {τ}_{b} = \frac{hc}{{σ}_{b} \cdot {η}_{b} \cdot {λ}_{b}} \\ {F}_{g} ≡ {I}_{g} \cdot {τ}_{g} = \frac{hc}{{σ}_{g} \cdot {η}_{g} \cdot {λ}_{g}} . \qquad Equation ( 10 )$$

Physically, F_{b} is the photochromic conversion fluence, when there is only a blue beam illumination, and F_{g} is the photochromic conversion fluence when there is only a green beam illumination. The dual wavelength (blue and green) illumination photochromic conversion fluence is given by

$$\begin{matrix}F ≡ {I}_{b} \cdot τ \\ = \frac{{F}_{b}}{1 + ( \frac{{I}_{g}}{{I}_{b}} ) \cdot \frac{{F}_{b}}{{F}_{g}}}\end{matrix} \qquad Equation ( 11 )$$

For a dual wavelength, blue beam and green beam, illumination, the cyclization photochromic conversion fluence F is given by equation 11. This equation shows that the cyclization photochromic conversion fluence is directly impacted by the intensity ratio I_{g}/I_{b}. When I_{g} goes to zero, i.e., no green beam illumination, F equals F_{b}, as expected. As the intensity ratio increases, photochromic conversion fluence F decreases.

The normalized cyclization photochromic conversion amplitude A is given by

$$\begin{matrix}A ≡ 1 - \frac{{N}_{t \to ∞}}{{N}_{0}} \\ = \frac{1}{1 + ( \frac{{I}_{g}}{{I}_{b}} ) \cdot \frac{{F}_{b}}{{F}_{g}}}\end{matrix} \qquad Equation ( 12 )$$

As the intensity ratio increases, the normalized photochromic conversion amplitude decreases. The normalized photochromic conversion amplitude A and the photochromic conversion fluence F have the same dependence on the intensity ratio I_{g}/I_{b}. F and A are mutually related by: F=F_{b}A.

In a single-bit system, each bit is an interference grating produced by two counter-propagating beams, typically with Gaussian intensity profiles that overlap at their focuses. Ideally, the bit has a size of the beam waist in transverse dimensions and a size of a couple of Rayleigh range (Z_{R}) in longitudinal dimension. Data bits are arranged layer by layer. The distance between two adjacent layers could be as small as twice that of the bit depth. Data capacity increases linearly with number of layers.

Assume a recording beam to be a focused Gaussian beam at blue wavelength, and fluence used for recording a single bit to be F₀, with N recording layers in a disk. At a fixed location in layer L(i), a total fluence at this location during recording (all data bits) at a different layer L(j) is ˜F₀/2, assuming half of the bits are 1 and half are 0. This is roughly independent of the distance D between these layers, as beam exposure time at that location scales as D², while beam intensity scales as 1/D² (due to a longer distance between the two layers), and these two factors cancel each other.

In a single-wavelength technique, in an N layer system, total fluence experienced by the layer L(i) during recording all the other (N−1) layers is (N−1)F₀/2. This is a background fluence that consumes material dynamic range but does not contain any data information. Compared with the fluence F₀ for recording a bit, this background fluence is ˜N/2 times higher. This means that the dynamic range that is usable for data is reduced to ˜(2/N) of the total dynamic range of the material, i.e., the majority of the material dynamic range is wasted as a result of undesirable background dye photochromic conversion during recording at adjacent layers. The usable dynamic range scales down linearly with the number of layers N. The higher the number of data layers, the greater the loss of the dynamic range. This presents a very serious problem for high capacity storage.

Now considering the case when dual wavelengths, for example, blue and green are used, with the blue beam forming the ring-closed product and the green beam reversing this process to regenerate the initial ring-open form. The green beam is therefore added to control the cyclization photochromic conversion process. Assuming the green beam is a plane wave throughout the sample, i.e., intensity I_{g} is uniform, for a fixed location at the layer L(i), total fluence of the blue light experienced by that location during recording at a single different layer is still F₀/2. However, in the dual wavelength case, background photochromic conversion amplitude is not determined by the fluence of the blue beam. Rather, it depends on the intensity ratio of the green beam to the blue beam at that location. The higher the intensity ratio, the lower the normalized photochromic conversion amplitude. Furthermore, the total background photochromic conversion amplitude is not a summation of background photochromic conversion from all other layers. Rather, it is limited by the highest background photochromic conversion amplitude from a single layer due to the balance of the backward and forward photochromic conversion dynamics induced by the two wavelengths. The highest background photochromic conversion for L(i) comes from recording at its adjacent layer L(i−1) or L(i+1), as the intensity ratio I_{g}/I_{b} is the smallest in this situation. Assuming the distance between two adjacent layers is 4Z_{R}, blue beam intensity I_{b} at L(i), adjacent to the recording layer, is ˜(¼)²I_{b,0}, I_{b,0} is blue beam intensity at the recording layer. Based on the two-wavelength photochromic conversion analysis presented above, the normalized photochromic conversion amplitude at L(i) is 1/(1+16α), where α=(F_{b}/F_{g})(I_{g}/I_{b,0}), where I_{b,0} is the intensity at the focal point (peak intensity). The normalized photochromic conversion amplitude at the recording layer is 1/(1+α). In one embodiment, the focal point is found with the recording volume element. The usable dynamic range is 1/(1+α)-1/(1+16α). By adjusting I_{g}, α can be adjusted. The usable dynamic range could be ˜60% if α is ˜0.25. Compared with the single wavelength photochromic conversion scenario, in the case of dual wavelength photochromic conversion, the usable dynamic range does not demonstrate a decaying scaling relationship with the number of layers. This is a very significant advantage for multi-layer storage.

In accordance with one embodiment of the present invention is a method for bit-wise recording of holographic data. The method disclosed herein enables higher data capacity by preventing the loss of dynamic range due to background illumination during recording. The method includes irradiating an optically transparent substrate simultaneously with a holographic interference pattern and a photochromic conversion control illumination. FIG. 3 is a flow chart illustrating an exemplary process 42 of dual wavelength holographic data recording according to aspects of the present technique. Process 42 begins with step 44 of providing an optically transparent substrate. The optically transparent substrate includes photochemically active dyes that can be reversibly converted from one state to another. In step 46, the optically transparent dye is irradiated with a holographic interference pattern and a photochromic conversion control illumination. The pattern has a first wavelength λ₁ and an intensity I₁ both sufficient to convert in the presence of the photochromic conversion control beam, within a volume element of the substrate, at least some of the photochemically active dye into a photo-product. This produces within the irradiated volume element concentration variations of the photo-product corresponding to the holographic interference pattern and thereby producing an optically readable datum corresponding to the volume element. The photochromic conversion control beam has a second wavelength λ₂ and an intensity I₂ sufficient to control the photochromic conversion amplitude in the volume element. In some embodiments, the holographic interference pattern is created by interfering two coherent recording beams at the first wavelength.

In one embodiment, the holographic interference pattern and the photochromic conversion control illumination irradiate the optically transparent substrate simultaneously. In another embodiment, the holographic interference pattern and the photochromic conversion control illumination irradiate the optically transparent substrate sequentially. In a non-limiting example, the optically transparent substrate may be illuminated by the holographic interference pattern followed by the photochromic conversion control illumination or vice versa. In a further embodiment, the time periods of irradiation of the holographic interference pattern and the photochromic conversion control illumination, overlap. In a still further embodiment the time period of illumination of the holographic interference pattern is a subset of the time period of the irradiation of the photochromic conversion control illumination. In a non-limiting example, the photochromic conversion control illumination starts before the onset of the illumination by the holographic interference pattern and is on for a period of time after the illumination by the holographic interference pattern has ceased. In a further example, the irradiation by holographic interference pattern and the photochromic conversion control illumination start simultaneously and end at different times.

In a further embodiment, the control beam illuminates a volume of the optically transparent substrate overlapping at least in part a volume illuminated by the holographic interference pattern. In a still further embodiment, the photochromic conversion control illumination is a beam at an angle to the recording beams. In one embodiment, the angle is in a range of about 0 degrees to plus or minus 180 degrees. In a further embodiment, the angle is in a range of about plus or minus 0 degrees to plus or minus 90 degrees.

In some embodiments, the first wavelength is selected to be in a range from about 350 nanometers to about 450 nanometers. In further embodiments, the first wavelength is selected to be in a range from about 375 nanometers to about 425 nanometers. Similarly, in some embodiments, the second wavelength is selected to be in a range from about 450 nanometers to about 900 nanometers. In further embodiments, the second wavelength is selected to be in a range from about 500 nanometers to about 700 nanometers.

The ratio of the intensity of holographic interference pattern can be altered to obtain a desired photochromic conversion amplitude in a selected holographic medium. In one embodiment, I₂/I₁ is in a range from about 0.02 to about 4. In accordance with another embodiment of the present invention is a dual wavelength system for holographic data recording. The system includes a holographic interference pattern generating source, wherein the interference pattern generating source emits at a first wavelength λ₁ and an intensity I₁. The system further includes a photochromic conversion control source, wherein the photochromic conversion control source emits at a second wavelength λ₂ not equal to λ₁ and an intensity I₂.

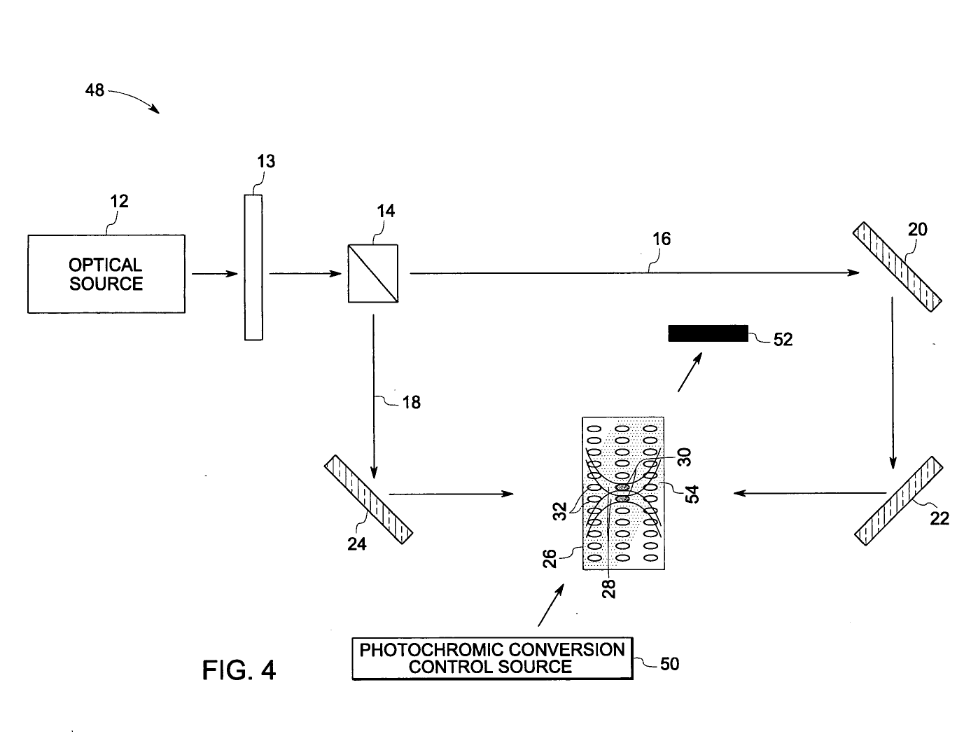

Referring to FIG. 4, an exemplary embodiment of a dual wavelength bit wise holographic recording system 48 is illustrated. The system 48 includes a laser source 12, which emits coherent radiation in the blue-violet region, which is split into at least two beams 16, 18 by beam splitter 14. Beams 16 and 18 are steered towards a point in the volume of a holographic data storage medium 26 by a series of mirrors 20, 22, 24. Additional focusing optics may be used to focus the beams to a spot and at various depths within the volume of the holographic medium 26. The beams interfere within the volume of the medium 26 to record the data as holographic microgratings 30. The system further includes a photochromic conversion control illumination source 50. The irradiation time, focus and illumination area of the recording beam and control beam may be scheduled to optimize the capacity of the system. As shown schematically in FIG. 4, while dyes in the waist 28 of the recording beams are bleached to form microholograms, those dyes 32 that are out of the beam waist also fall within the beam illumination cone. But since a volume 54 is also reversibly bleached by radiation from the photochromic conversion control source 50, the dyes 32 that are out of the beam waist but fall within the beam illumination cone are not forward bleached as is the case in a single wavelength bit-wise holographic recording as shown in FIG. 1.

In accordance with another embodiment of the present invention, is a pre-recorded holographic storage medium. The pre-recorded holographic data storage medium is prepared by a method including the steps of providing an optically transparent substrate including a photochemically active dye and irradiating the optically transparent substrate with a holographic interference pattern and a photochromic conversion control illumination producing an optically readable datum corresponding to a volume element. In one embodiment the holographic data storage medium includes greater than 4 recorded layers in the thickness of the holographic data storage medium. In a further embodiment, the holographic data storage medium includes greater than 10 recorded layers in the thickness of the holographic data storage medium. In a still further embodiment, the holographic data storage medium includes greater than 20 recorded layers in the thickness of the holographic data storage medium. In one embodiment, the holographic data storage medium includes greater than 40 recorded layers in the thickness of the holographic data storage medium. In some embodiments of the present invention, the data storage medium has an areal density of individual data bits greater than 0.01 bits of data per square micron.

Optically transparent plastic materials may be advantageously employed in the preparation of the optically transparent substrate. Optically transparent plastic materials used in producing holographic data storage media (such as the optically transparent substrate) can comprise any plastic material having sufficient optical quality, e.g., low scatter, low birefringence, and negligible losses at the wavelengths of interest, to render the data in the holographic storage material readable.

Organic polymeric materials, such as for example, oligomers, polymers, dendrimers, ionomers, copolymers such as for example, block copolymers, random copolymers, graft copolymers, star block copolymers; and the like, or a combination comprising at least one of the foregoing polymers can be used. Thermoplastic polymers or thermosetting polymers can be used. Examples of suitable thermoplastic polymers include polyacrylates, polymethacrylates, polyamides, polyesters, polyolefins, polycarbonates, polystyrenes, polyesters, polyamideimides, polyaromaticates, polyaromaticsulfones, polyethersulfones, polyphenylene sulfides, polysulfones, polyimides, polyetherimides, polyetherketones, polyether etherketones, polyether ketone ketones, polysiloxanes, polyurethanes, polyaromaticene ethers, polyethers, polyether amides, polyether esters, or the like, or a combination comprising at least one of the foregoing thermoplastic polymers. Some more possible examples of suitable thermoplastic polymers include, but are not limited to, amorphous and semi-crystalline thermoplastic polymers and polymer blends, such as: polyvinyl chloride, linear and cyclic polyolefins, chlorinated polyethylene, polypropylene, and the like; hydrogenated polysulfones, ABS resins, hydrogenated polystyrenes, syndiotactic and atactic polystyrenes, polycyclohexyl ethylene, styrene-acrylonitrile copolymer, styrene-maleic anhydride copolymer, and the like; polybutadiene, polymethylmethacrylate (PMMA), methyl methacrylate-polyimide copolymers; polyacrylonitrile, polyacetals, polyphenylene ethers, including, but not limited to, those derived from 2,6-dimethylphenol and copolymers with 2,3,6-trimethylphenol, and the like; ethylene-vinyl acetate copolymers, polyvinyl acetate, ethylene-tetrafluoroethylene copolymer, aromatic polyesters, polyvinyl fluoride, polyvinylidene fluoride, and polyvinylidene chloride.

In some embodiments, the thermoplastic polymer, used in the methods disclosed herein as a substrate, is made of a polycarbonate. The polycarbonate may be an aromatic polycarbonate, an aliphatic polycarbonate, or a polycarbonate comprising both aromatic and aliphatic structural units.

Examples of useful thermosetting polymers include those selected from the group consisting of an epoxy, a phenolic, a polysiloxane, a polyester, a polyurethane, a polyamide, a polyacrylate, a polymethacrylate, or a combination comprising at least one of the foregoing thermosetting polymers.

The photochemically active dye may be admixed with other additives to form a photo-active material. Examples of such additives include heat stabilizers; antioxidants; light stabilizers; plasticizers; antistatic agents; mold releasing agents; additional resins; binders, blowing agents; and the like, as well as combinations of the foregoing additives. The photo-active materials are used for manufacturing holographic data storage media.

Cycloaliphatic and aromatic polyesters can be used as binders for preparing the photo-active material. These are suitable for use with thermoplastic polymers, such as polycarbonates, to form the optically transparent substrate. These polyesters are optically transparent, and have improved weatherability, low water absorption and good melt compatibility with the polycarbonate matrix. Cycloaliphatic polyesters are generally prepared by reaction of a diol with a dibasic acid or an acid derivative, often in the presence of a suitable catalyst.

Generally, the photochemically active dyes and polymers used for forming the optically transparent substrate, and the holographic data storage medium should be capable of withstanding the processing conditions used to prepare the holographic data storage medium, for example during a step in which the photochemically active nitrone and any additional additives which may be present are compounded with a polymer powder and subsequently molded into data storage discs.

In an embodiment, the photochemically active dye is present in an amount from about 0.1 to about 10 weight percent, based on the total weight of the optically transparent substrate, and has a UV-visible absorbance in a range between about 0.1 and about 1 at a wavelength in a range between about 300 nm and about 800 nm. Such dyes are used in combination with other materials, such as, for example, binders to form photo-active materials, which in turn are used for manufacturing holographic data storage media.

In one embodiment, a film of an optically transparent substrate including an optically transparent plastic material and at least one photochemically active dye is formed. Generally, the film is prepared by molding techniques using a molding composition that is obtained by mixing the dye with an optically transparent plastic material. Mixing can be conducted in machines such as a single or multiple screw extruder, a Buss kneader, a Henschel, a helicone, an Eirich mixer, a Ross mixer, a Banbury, a roll mill, molding machines such as injection molding machines, vacuum forming machines, blow molding machine, or then like, or a combination comprising at least one of the foregoing machines. Alternatively, the dye, and the optically transparent plastic material may be dissolved in a solution and films of the optically transparent substrate can be formed from the solution.

In one embodiment a data storage composition including a photochemically active dye and a thermoplastic polymer is injection molded to form an article that can be used for producing holographic data storage media. The injection-molded article can have any geometry. Examples of suitable geometries include circular discs, square shaped plates, polygonal shapes, or the like. The thickness of the articles can vary, from being at least 100 micrometers in an embodiment, and at least 250 micrometers in another embodiment. A thickness of at least 250 micrometers is useful in producing holographic data storage disks that are comparable to the thickness of current digital storage discs.

Without further elaboration, it is believed that one skilled in the art can, using the description herein, utilize the present invention to its fullest extent. The following examples are included to provide additional guidance to those skilled in the art in practicing the claimed invention. The examples provided are merely representative of the work that contributes to the teaching of the present application. Accordingly, these examples are not intended to limit the invention, as defined in the appended claims, in any manner.

### EXAMPLES

Several samples of diarylethene (structural formula VII) doped thermoplastic disks were prepared. The dye (VII) was prepared according to standard procedures known in the art. The dye was blended with polycarbonate optical quality powder and the blend injection molded to form small disks. The disks were about 5 cm in diameter and 1 mm in thickness. The diarylethene concentration was about 0.26 wt %.

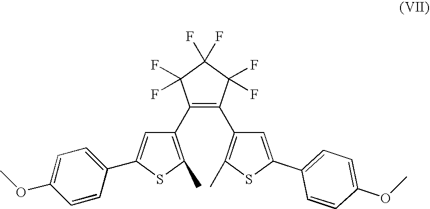

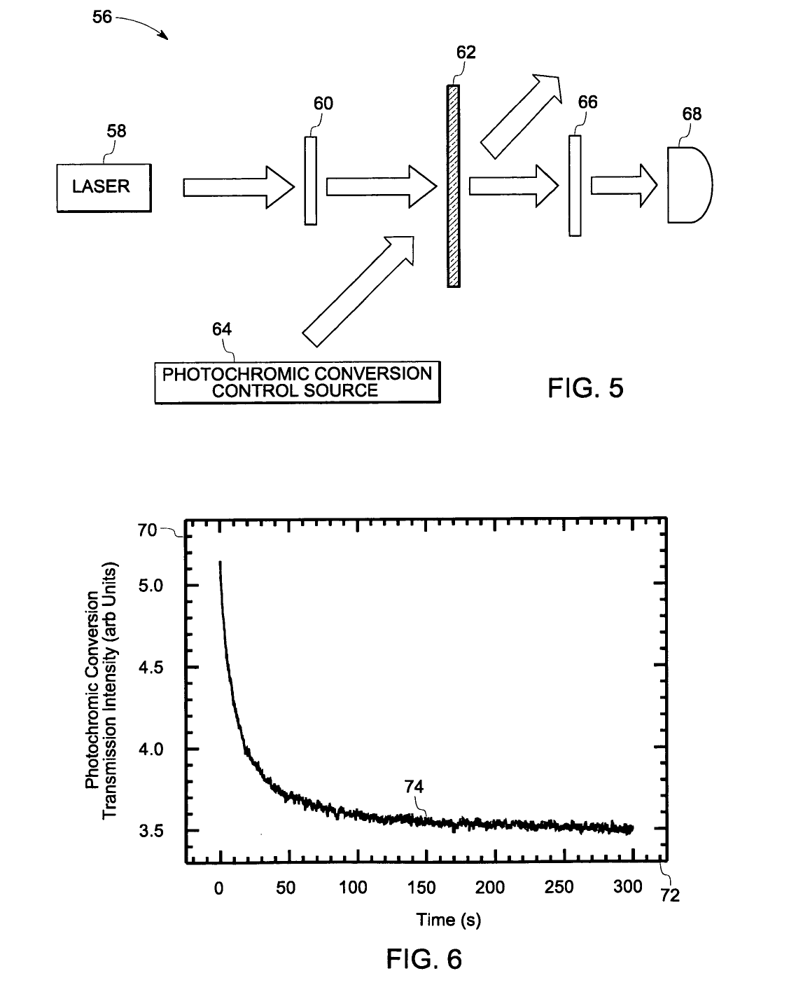

FIG. 5 is a schematic representation of a dual wavelength photochromic conversion system 56 used in this example. The sample 62 was illuminated by a beam from a laser source 58 having a wavelength of 405 nm beam (blue beam) at normal incidence to the disk. A mechanical shutter 60, controlled by a computer, was used to pulse (turn on and off) the 405 nm laser beam being incident on the sample 62. At an oblique angle of 45 degrees, a 532 nm beam (green beam) illuminated the sample, overlapping a volume illuminated by the blue beam. Green beam illumination of the sample was initiated prior to blue beam illumination to confine the dyes to the ring-open form prior to the beginning of the photochromic conversion process by the blue beam and continued throughout the photochromic conversion process by the blue beam. The blue beam transmitted through the sample was incident on a neutral density filter 66. The filtered blue beam power was collected by detector 68. Data acquisition started when the blue beam was first incident on the sample and stopped when the blue beam was shuttered off.

The power of the blue beam incident on the sample was fixed at 11.70 mW (milliwatts), while the power of the green beam was varied from 0.99 mW to 135 mW. Spot size of the blue beam on the sample was 4.1 mm in diameter. Spot size of the green beam was 6 mm in diameter and it projected an elliptical spot on the disk. Monitoring of the photochromic conversion process lasted for a few hundred seconds, until a steady state was reached.

FIG. 6 shows a typical photochromic conversion monitoring curve (74) for a green beam power of 13 mW. The Y-axis (70) represents the transmission intensity and X-axis (72) represents the photochromic conversion time. The intensity of the transmitted blue beam decreases exponentially with photochromic conversion time. This results due to the absorption cross-section at the blue wavelength of the diarylethene dye being higher when it is in the ring-closed form than the ring-open form. As the ring-open form of the diarylethene dye is converted to the ring-closed form of the diarylethene dye on absorption of radiation at the blue wavelength, the absorption levels at the blue wavelength start to increase. The exponential decay behavior is expected because photochromic conversion rate of the dyes depends linearly on the concentration of the dyes to be bleached.

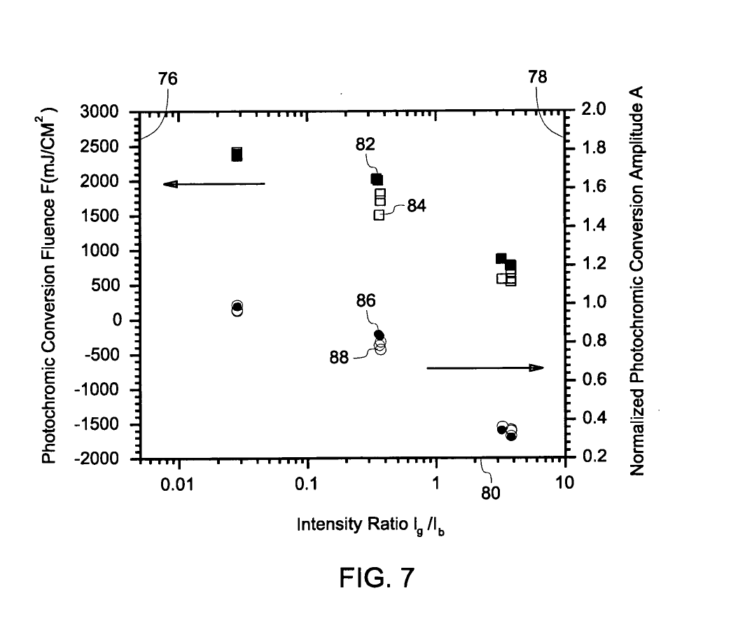

FIG. 7 shows both photochromic conversion fluence and normalized photochromic conversion amplitude decrease as the relative intensity of the green beam to the blue beam (I_{g}/I_{b}) increases. FIG. 7 illustrates the variation in both photochromic conversion fluence F (Y₁ axis 76) and the normalized photochromic conversion amplitude A (Y₂ axis 78) with variation in the green beam intensity I_{g} to blue beam intensity ratio (X-axis 80). A stated above, the blue beam intensity I_{b} was fixed while the green beam intensity I_{g} was varied. As discussed above, the photochromic conversion process for dual wavelength photochromic conversion is controlled by the relative intensity of these two beams. In FIG. 7, filled square markings 82 indicate the experimentally obtained photochromic conversion fluence and unfilled square markings 84 indicate theoretically obtained results. Similarly, filled circular markings 86 indicate the experimentally obtained normalized photochromic conversion amplitude and unfilled circular markings 88 indicate theoretically obtained results. Experimental results substantially match the theoretical predictions. The dyes in the sample were in the ring-open form prior to the photochromic conversion. When there is no blue beam illumination, i.e., I_{g}/I_{b} goes to infinity. As there is no change of forms for the dyes in the absence of blue illumination, the normalized photochromic conversion amplitude goes to zero. As the blue beam power increases, more and more dyes are changed to the ring-closed form and thus the normalized photochromic conversion amplitude increases.

Table 1 shows averages of photochromic conversion fluence and normalized photochromic conversion amplitude at three different I_{g}/I_{b} levels. As the intensity ratio I_{g}/I_{b} increases from 0.028 to 3.8 (i.e., by a factor of about 100), both the photochromic conversion fluence and normalized photochromic conversion amplitude decrease by roughly a factor of 3. At an intensity ratio of 0.028, the photochromic conversion fluence is 2385 mJ/cm², which is very close to that in a single blue beam illumination case (˜2434 mJ/cm²).

TABLE 1
Average bleaching Fluence and Average Normalized amplitude.

| Ratio of Green beam | | |
|---|---|---|
| intensity to blue beam | Average Bleaching | Average Normalized |
| intensity I_{g}/I_{b} | (mJ/cm) | amplitude |
| 0.02 | 2386.2 | 0.9 |
| 0.3 | 1674.9 | 0.7 |
| 3.8 | 622.6 | 0.3 |

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method for bit-wise holographic data recording, the method comprising:
providing an optically transparent substrate comprising a photochemically active dye; and
irradiating the optically transparent substrate with a holographic interference pattern and a photochromic conversion control illumination, wherein the pattern has a first wavelength λ₁ and an intensity I₁ both sufficient to convert in the presence of the photochromic conversion control beam, within a volume element of the substrate, at least some of the photochemically active dye into a photo-product, and producing within the irradiated volume element concentration variations of the photo-product corresponding to the holographic interference pattern thereby producing an optically readable datum corresponding to the volume element, and wherein the photochromic conversion control illumination has a second wavelength λ₂ and an intensity I₂ to control the photochromic conversion amplitude in the volume element, wherein the second wavelength is not equal to the first wavelength.

2. The method of claim 1, wherein the photochromic conversion control illumination illuminates a volume of the optically transparent substrate overlapping at least in part a volume illuminated by the holographic interference pattern.

3. The method of claim 1, wherein irradiating the optically transparent substrate with a holographic interference pattern comprises interfering two recording beams at the first wavelength within the volume element.

4. The method of claim 3, wherein the photochromic conversion control illumination is a beam at an angle to the recording beams.

5. The method of claim 1, wherein the holographic interference pattern and the photochromic conversion control illumination irradiate the optically transparent substrate simultaneously.

6. The method of claim 1, wherein the holographic interference pattern and the photochromic conversion control illumination irradiate the optically transparent substrate sequentially.

7. The method of claim 1, wherein the first wavelength is selected to be in a range from about 350 nanometers to about 450 nanometers.

8. The method of claim 1, wherein the second wavelength is selected to be in a range from about 450 nanometers to about 900 nanometers.

9. The method of claim 1, wherein I₂/I₁ is in a range from about 0.02 to about 4.

10. The method of claim 1, wherein the photochromic conversion fluence of the holographic interference pattern is F₁ and the photochromic conversion fluence of the photochromic conversion control illumination is F₂, wherein the peak intensity of the holographic interference pattern within a recording in the volume element is I_{1,0} and wherein α=(F₁/F₂)(I₂/I_{1,0}) is in a range from about 0.1 to 10.

11. The method of claim 1, wherein the photo-product comprises a photo-decomposition product, a product of oxidation, a product of reduction, a product of bond breaking, or a molecular rearrangement product.

12. The method of claim 1, wherein the photochemically active dye is a photochemically reversible active dye.

13. The method of claim 1, wherein the photochemically active dye comprises a dye material comprising vicinal diarylethenes, fulgides and fulgimides, spiropyrans, spirooxazines, naphtopyrans and combinations thereof.

14. The method of claim 1, wherein the photochemically active dye is a vicinal diarylethene, wherein the vicinal diarylethene comprises a material comprising of diarylperfluorocyclopentenes, diarylmaleic anhydrides, diarylmaleimides and combinations thereof.

15. The method of claim 1, wherein the photochemically active dye is a vicinal diarylethene, wherein the vicinal diarylethene has a structure (I) 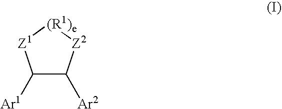
wherein “e” is 0 or 1; R¹ is a bond, an oxygen atom, a substituted nitrogen atom, a sulfur atom, a selenium atom, a divalent C₁-C₂₀ aliphatic radical, a halogenated divalent C₁-C₂₀ aliphatic radical, a divalent C₃-C₂₀ cycloaliphatic radical, a halogenated divalent C₁-C₂₀ cycloaliphatic radical, or a divalent C₂-C₃₀ aromatic radical; Ar¹ and Ar² are each independently a C₂-C₄₀ aromatic radical, or a C₂-C₄₀ heteroaromatic radical; and Z¹ and Z² are independently a bond, a hydrogen atom, a monovalent C₁-C₂₀ aliphatic radical, divalent C₁-C₂₀ aliphatic radical, a monovalent C₃-C₂₀ cycloaliphatic radical, a divalent C₃-C₂₀ cycloaliphatic radical, a monovalent C₂-C₃₀ aromatic radical, or a divalent C₂-C₃₀ aromatic radical.

16. The method of claim 1, wherein the photochemically active dye is present in an amount from about 0.1 to about 10 weight percent, based on the total weight of the optically transparent substrate.

17. The method of claim 1, wherein the optically transparent substrate comprises an optically transparent plastic material.

18. The method of claim 1, wherein the optically transparent substrate comprises a thermoplastic polymer, a thermosetting polymer, or a combination of a thermoplastic polymer and a thermosetting polymer.

19. The method of claim 18, wherein the thermoplastic polymer comprises a polycarbonate.

20. A bit-wise pre-recorded holographic data storage medium prepared by a method comprising:
providing an optically transparent substrate comprising a photochemically active dye; and
irradiating the optically transparent substrate with a holographic interference pattern and a photochromic conversion control illumination, wherein the pattern has a first wavelength λ₁ and an intensity I₁ both sufficient to convert in the presence of the photochromic conversion control beam, within a volume element of the substrate, at least some of the photochemically active dye into a photo-product, and producing within the irradiated volume element concentration variations of the photo-product corresponding to the holographic interference pattern thereby producing an optically readable datum corresponding to the volume element, and wherein the photochromic conversion control illumination has a second wavelength λ₂ and an intensity I₂ to control the photochromic conversion amplitude in the volume element, wherein the second wavelength is not equal to the first wavelength,
wherein the data storage medium comprising greater than 4 recorded layers in the thickness of the holographic data storage medium.

21. The pre-recorded holographic data storage medium of claim 20, wherein the photochemically active dye is a reversible photochemically active dye.

22. The pre-recorded holographic data storage medium of claim 21, wherein the data storage medium has an areal density of individual data bits greater than 0.01 bits of data per square micron.

23. A holographic data recording system comprising:
a holographic interference pattern generating source, wherein the holographic interference pattern has a peak Intensity I_{1,0} and photochromic conversion fluence F₁ within a recording volume element; and
a photochromic conversion control illumination generating source, wherein the photochromic conversion control illumination has an intensity I₂ and photochromic conversion fluence F₂ within the recording volume element;
wherein α=(F₁/F₂)(I₂/I_{1,0}) is in a range from about 0.1 to 10.
